(19) United States
(12) Patent Application Publication
(10) Pub. No.: US 2012/0085378 A1
(43) Pub. Date: Apr. 12, 2012

(54) Ambulatory Assistive Devices With Improved Visual Safety

(76) Inventor: Koushick Chakraborty, Johnson City, TN (US)

(21) Appl. No.: 13/271,153

(22) Filed: Oct. 11, 2011

Related U.S. Application Data
(60) Provisional application No. 61/392,233, filed on Oct. 12, 2010.

(51) Int. Cl. A61H 3/00; A45B 3/04

(52) U.S. Cl. 135/66; 135/65

(57) ABSTRACT

A novel medical ambulatory assistive device with improved visual safety. The frame set of an ambulatory assistive device is coated with photo luminescent pigments for visibility in poorly lighted surroundings. An automatically controlled LED lighting unit is mounted on the frame set to provide sufficient visual safety for walking around in poorly lighted area with the device.

### CROSS-REFERENCE

Priority is claimed from the U.S. Provisional Patent Application No. 61/392,233, filed on Oct. 12, 2010, which is hereby incorporated by reference.

### DESCRIPTION OF RELATED ART

The present application relates to an ambulatory assistive device, and more particularly to an ambulatory assistive device with visual safety aid and motion sensitive lighting.

Note that the points discussed below may reflect the hindsight gained from the disclosed inventions, and are not necessarily admitted to be prior art.

Falls are the major cause of injury-related visits to emergency departments in the United States and the primary etiology of accidental deaths in persons over 65 years of age. The mortality rate for falls increases dramatically with age in both sexes and in all racial and ethnic groups. Apart from the mortality and financial burden; falls are the leading cause of significant morbidity among the elderly population who has sustained falls. The injury rate for falls is highest among persons 85 years of age and older. Approximately fifty percent of total number of falls happens at home. There are many contributing factors behind falls in elderly and people with mild dementia. One of the factors is inadequate lighting.

Handheld lighting devices have been designed for joggers, such as the one described in U.S. Pat. No. 5,428,514 wherein a switch is used for turning on the light. Such devices are not very useful for elderly, people with mild dementia and/or bodily injury. Requiring them to wear or hold such devices would constitute extra burden for their body, also people with dementia often forget to turn the device on.

The ambulatory assistive devices currently commercially available for assisting walking, such as walkers, canes, walking sticks, quad canes, have been designed to be light and easy to operate for elderly, people who walk with difficulty and/or with dementia. Example ones include the ones described in U.S. Pat. No. 6,913,279 B1. However, users may often fall on the way to locate the devices in the dark, or fall again because of insufficient lighting. With both hands holding onto a walker or a cane, turning on light generally becomes a tough task. There is a need for additional safety features for these traditional ambulatory assistive devices.

### SUMMARY

The present application discloses new approaches to improve the safety features of ambulatory assistive devices.

In one embodiment, an ambulatory assistive device is painted or coated with photo luminescent material on the surface which glows in the dark.

In one embodiment, a motion sensitive LED (Light Emitting Diode) light is mounted on an ambulatory assistive device that automatically turns on and off upon sensing of motions within a distance.

In one embodiment, a sound sensitive LED light is mounted on an ambulatory assistive device that automatically turns on and off upon sensing of sounds within a distance.

In one aspect of an embodiment, the mounted LED light is turnable for different lighting directions.

In one aspect of an embodiment, the mounted LED light also has a sensor for brightness, only when the brightness is sufficiently low can the LED light be activated, extending the lifetime of the battery.

With the above features of an ambulatory device, there will be improved safety for elderly or injured people for walking around, thus reduced risk for falls again. There would also be increased peace of mind for people who need ambulatory assistive devices knowing that the falling risks in walking around are reduced. The innovation provides an easy and quick way to locate walking devices in the dark; it eliminates the anxiety associated with having to rush; it improves the functionality of a conventional ambulatory device in poor lighting; and provides opportunity for few continuous, instant visual cues for people with mild dementia.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows a prospective view of an example ambulatory assistive device equipped with motion sensitive LED lights in accordance with this application.

FIG. 2 schematically illustrates an example mounting of a LED unit on a quad cane in accordance with this application.

FIG. 3 demonstrates the effect of photo luminescent tapes attached to the bars of an example walker in accordance with this application.

FIG. 4A demonstrates the effect of a motion sensitive LED light unit mounted on an example walker in accordance with this application.

FIG. 4B demonstrates the effect of a motion sensitive LED light unit mounted on an example quad cane in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to all types of ambulatory assistive devices that are for use of elderly or people with walking difficulties, for example, canes, walking sticks, walkers, quad canes, etc; for clarity reason, the examples are given based on a walker or a cane, but an ordinary person in the art would know the variations to modify the design to make it suitable for other ambulatory assistive devices.

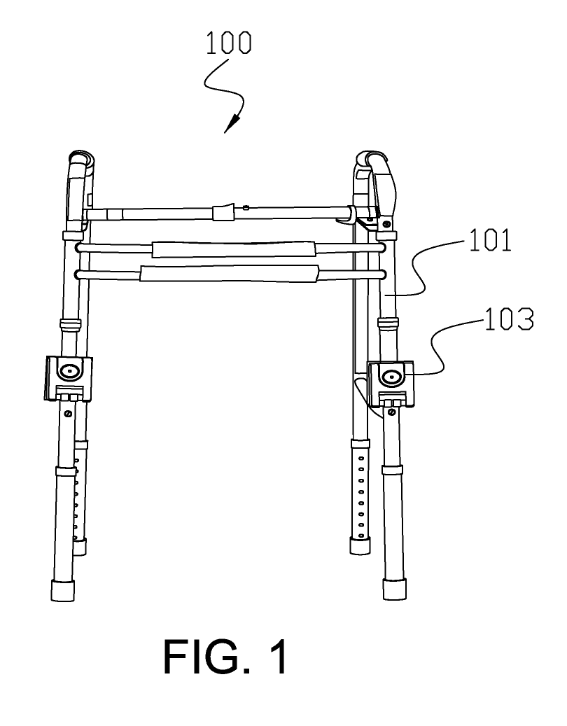

In reference to FIG. 1, an example walker 100 with visual safety includes walker legs 101, holding arms 107, supporting bars 105 and a motion sensitive LED lighting units 103 mounted on walker legs 101. An example of manufacturing and making of a walker is described in U.S. Pat. No. 6,913,279 B1, the entirety of which is hereby incorporated by reference.

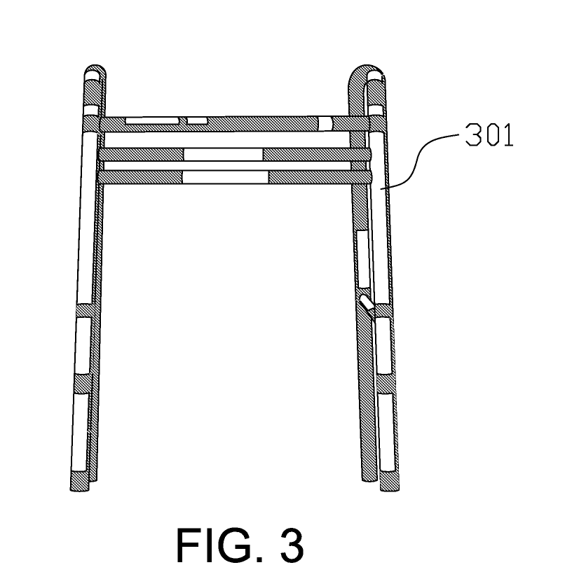

On the frames, such as legs 101, supporting bars 105, holding arms 107, they are coated with photo luminescent paint or photo luminescent tapes 109 for emission of light in dark. Durable epoxy coatings with photo luminescent pigments may be used for example. Many commercially available non-toxic photo luminescent pigments can emit light in the dark for 24 hours after being excited by natural day lighting. FIG. 3 shows the effect of fluorescence of the walker frame in the dark. This visibility allows people to easily locate an ambulatory assistive device in dark.

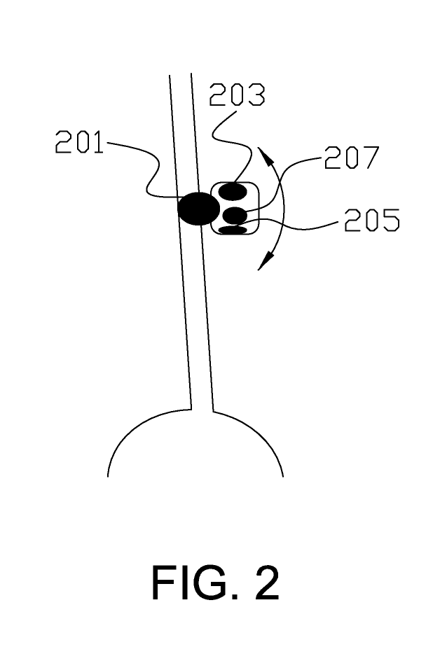

In reference to FIG. 2, a motion or sound sensitive LED lighting unit 200 is mounted on leg 209 of a walker or cane through commercially available screws and mounting rings 201 or other mounting tools. LED lighting unit 200 may include a sensor system 203 for sensing motion or sounds and light, battery 207, LED light 205 and controlling system 211. LED lighting 205 is controlled by both the level of brightness of the surrounding and by sensing of motion or sound with the signals sent from sensor system 203. It is automatically turned off during the day light to save battery. In poor lighting surrounds LED lighting unit 200 is activated and motions or sounds detected within several feet of the ambulatory device will then automatically turn on the LED light.

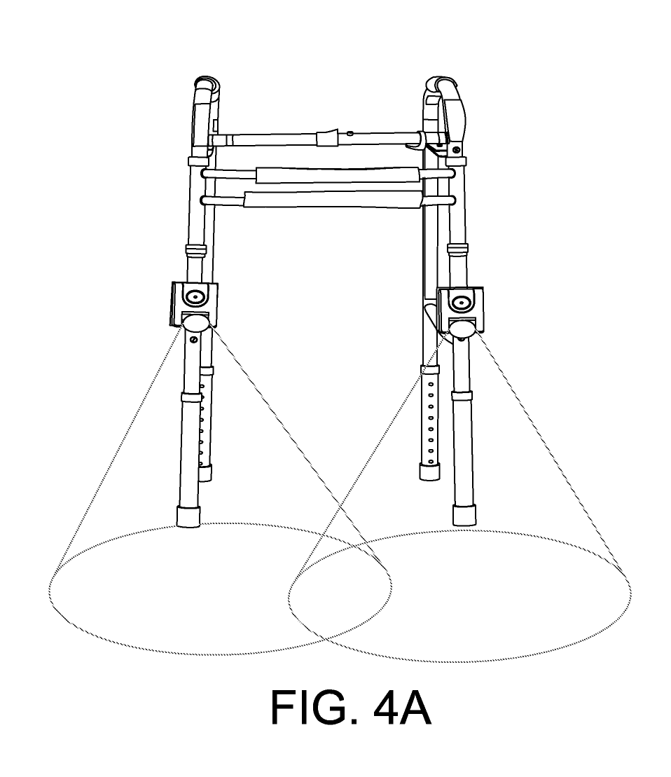

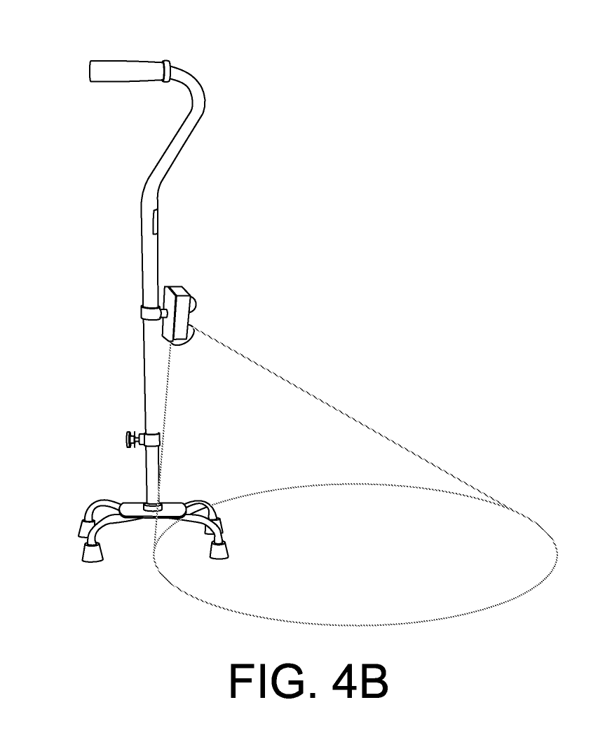

An example such LED lighting unit is described in PCT Patent Application Publication WO 2008/091528 A2, the entirety of which is hereby incorporated by reference. FIGS. 4A and 4B show the effect of equipping a walker and a cane with such LED lighting unit.

The mounting of LED lighting unit may be configured to be turnable so that LED lighting can flash to different directions.

These simple and cost effective functional improvements of the traditional designs of ambulatory assistive devices provide additional safety features to these devices. By fluorescent marking of the frames of ambulatory assistive device and by providing adequate lighting with automatic on and off features, these improvements reduce or prevent occurrence of falls among elderly and people with mild dementia and help to sustain, improve functional independence and prevent potential hospitalization and subsequent institutionalization.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. An ambulatory assistive device, comprising:
a frame set configured to function as a medical ambulatory assistive device, wherein said frame set is coated with a layer of non-toxical photo luminescent pigment material and said photo luminescent pigment material emits sufficiently light in dark.

2. The ambulatory assistive device of claim 1, further comprising an automatically controlled LED lighting unit mounted on said frame set and said LED lighting unit is inactivated by sufficient light on its back area and activated by insufficient light in its back area.

3. The ambulatory assistive device of claim 2, wherein said LED lighting unit comprises a motion sensor generating signals corresponding to motion sensed in surrounding area; and a LED lighting mechanism, wherein LED lighting mechanism is controlled by said signals.

4. The ambulatory assistive device of claim 2, wherein said LED lighting unit comprises a sound sensor generating signals corresponding to sounds sensed in surrounding area; and a LED lighting mechanism, wherein LED lighting mechanism is controlled by said signals.

5. The ambulatory assistive device of claim 2, wherein said frame set is a walker.

6. The ambulatory assistive device of claim 2, wherein said frame set is a cane.

7. The ambulatory assistive device of claim 2, wherein said frame set is a walking stick.
